(19) United States
(12) Patent Application Publication
(10) Pub. No.: US 2026/0327996 A1
(43) Pub. Date: Oct. 22, 2026

(54) METHOD FOR PRODUCING A CERAMIC PANEL, AND CERAMIC PANEL OBTAINED THEREWITH

(71) Applicant: UNILIN, BV, Wielsbeke (BE)

(72) Inventors: Marijn SEYNAEVE, Wielsbeke (BE); Benjamin CLEMENT, Wielsbeke (BE)

(21) Appl. No.: 19/110,484

(22) PCT Filed: Sep. 5, 2023
(86) PCT No.: PCT/IB2023/058755

§ 371 Date: Mar. 11, 2025

Related U.S. Application Data
(60) Provisional application No. 63/409,980, filed on Sep. 26, 2022.

(51) Int. Cl. E04F 15/08; C04B 16/06; C04B 28/00; C04B 41/00; C04B 111/00; E04F 15/02

(52) U.S. Cl. CPC E04F 15/082; C04B 16/0641; C04B 28/008; C04B 41/009; E04F 15/02038; C04B 2111/00612; E04F 2201/0153; E04F 2201/023; E04F 2201/042; E04F 2201/043

(57) ABSTRACT

The method includes the steps of: providing aluminosilicate particles, mixing the aluminosilicate particles with an alkaline composition, and optionally fibers, and optionally fillers, and optionally additives, thereby obtaining a raw material mixture comprising water; arranging the raw material mixture into panel-shape; compacting the panel-shaped mixture by means of pressure; applying a temperature between 50 °C and 200 °C to the compacted panel-shaped mixture during a time period; thereby generating a polycondensation reaction using the aluminosilicate particles thereby forming a ceramic board. The ceramic board is bonded by a geopolymer selected from an amorphous or a semi-crystalline polysialate geopolymer, an amorphous or a semi-crystalline poly(sialate-siloxo) geopolymer; or an amorphous or a semi-crystalline poly(sialate-disiloxo) geopolymer.

The invention relates to a method for producing a ceramic panel. The invention also relates to the production of ceramic panels having a surface decoration.

It is known to manufacture ceramic tiles via firing at high temperature, in a continuous roller kiln, of a green tile comprising ceramic raw materials in form of compacted powders. During firing the powders are sintered to consolidate the ceramic material and reduce the residual porosity thereof. The sintering process requires high temperatures, and thus high energy consumption in the kiln.

It is an object of the invention to provide a method for producing ceramic panels that do not require high temperatures for forming the ceramic matrix of the panel.

It is a further object of the invention to provide decorative panels comprising a ceramic panel, wherein the decorative panels have excellent properties and can be produced in an improved way.

It is a benefit of the invention that ceramic panels can be provided in a way that throughout all processes of production low amount of CO₂ is generated and energy consumption is lower than in the production of prior art ceramic panels.

The first aspect of the invention relates to a method for producing a panel, preferably a decorative panel, characterized in that the produced panel comprises a ceramic board. The method comprises the steps of:
providing aluminosilicate particles,
mixing the aluminosilicate particles with an alkaline composition, and optionally fibers, and optionally fillers, and optionally additives, thereby obtaining a raw material mixture comprising water;
arranging the raw material mixture into panel-shape;
compacting the panel-shaped mixture by means of pressure;
applying a temperature between 50 °C and 200 °C (and preferably below 150 °C, more preferably below 120 °C) to the compacted panel-shaped mixture during a time period; thereby generating a polycondensation reaction using the aluminosilicate particles thereby forming the ceramic board. The ceramic board is bonded by a geopolymer selected from an amorphous or a semi-crystalline polysialate geopolymer, an amorphous or a semi-crystalline poly(sialate-siloxo) geopolymer; or an amorphous or a semi-crystalline poly(sialate-disiloxo) geopolymer.

The method allows to make a panel comprising a ceramic board with low energy consumption and low environmental impact.

When applying the temperature to the compacted panel-shaped mixture during the time period, preferably a compacting pressure is maintained onto the panel-shaped mixture.

As an example, a temperature of 90 °C is applied to the compacted panel-shaped mixture during a time period of 10 minutes.

A preferred embodiment of the first aspect of the invention is characterized in that the alkaline composition is selected from waterglass, NaOH or KOH; or combinations thereof. Such embodiments are beneficial as optimum conditions are achieved for performing the polycondensation reaction that forms the geopolymer bonds in the ceramic board.

Preferably the alkaline composition is supplied as an aqueous solution. Such embodiments are favored as the alkaline composition can be added in an efficient way; and the water of the aqueous solution supports the processing.

When waterglass is used, the waterglass preferably is a Na-waterglass or a K-waterglass. Such embodiments result in panels of high quality, and the processing times can be kept limited.

A preferred embodiment of the first aspect of the invention is characterized in that the alkaline composition comprises waterglass xX₂0·ySiO₂; wherein X is Na or K. Preferably, the mol ratio SiO₂ to X₂0 in the waterglass is between 1.5 and 3.8, preferably between 1.8 and 2.8, more preferably between 1.8 and 2.5, even more preferably between 2 and 2.2. Such embodiments provide optimum conditions for the polycondensation reaction in which the geopolymer bonds are formed.

A preferred embodiment of the first aspect of the invention is characterized in that in the raw material mixture the ratio of the mass of the total amount of water to the mass of aluminosilicate particles is between 0.10 and 0.40, preferably between 0.20 and 0.30; more preferably between 0.23 and 0.26. Such embodiments provide for optimized processing conditions in the method.

A preferred embodiment of the first aspect of the invention is characterized in that the obtained ceramic board is less than 60 mm thick, preferably less than 30 mm thick, more preferably less than 20 mm thick, more preferably less than 14 mm thick, more preferably less than 10 mm thick, more preferably less than 8 mm thick.

Such embodiments provide panels that have excellent mechanical properties, e.g. bending strength. The panels are e.g. suited for use as floor panels.

A preferred embodiment of the first aspect of the invention is characterized in that the aluminosilicate particles are provided via the provision of or obtained from one or more than one of slag from a metallurgical process, fly ash and calcinated clay. It is a benefit that waste products from industrial processes can be used as raw material in the method. This allows valorization of products which are otherwise waste products.

A preferred embodiment of the first aspect of the invention is characterized in that the time period during which a temperature between 50 °C and 200 °C (and preferably below 150 °C, more preferably below 120 °C) is applied to the compacted panel-shaped mixture during lasts less than 30 minutes. It is benefit that the time during which the product needs to be kept at elevated temperature is limited. Therefore, energy consumption can be kept low.

A preferred embodiment of the first aspect of the invention is characterized in that the method comprises the step of post-curing the ceramic board. Preferably post-curing is at least partly conducted under controlled conditions of temperature and relative humidity. Preferably the post-curing involves between 2 and 5 days at room temperature, followed by between 24 and 48 hours at between 60 to 95 °C (preferably at dry air); preferably followed by 7 days at room temperature.

Such embodiments allow for the geopolymer to fully cure and achieve its final mechanical properties.

A preferred embodiment of the first aspect of the invention is characterized in that the alkaline composition comprises waterglass (xX₂0·ySiO₂; wherein X is Na or K), water, and MOH, wherein M is selected from Na or K. More preferably, the mol ratio of water to the X₂0 of the waterglass is between 5 and 15, more preferably between 7 and 13, even more preferably between 10 and 11. Such embodiments provide an optimized geopolymer, and thus optimum mechanical properties—e.g. bending strength—of the ceramic board.

A preferred embodiment of the first aspect of the invention is characterized in that water is added in order to obtain the raw material mixture. Such embodiments provide improved processability of the raw material mixture.

A preferred embodiment of the first aspect of the invention is characterized in that the raw material mixture comprises fillers, wherein the fillers comprise powders or granulates, e.g. CaCO₃, sand or grit. The fillers allow to minimize the amount of active ingredients in the raw material mixture, and to optimize the properties and cost of the ceramic board.

A preferred embodiment of the first aspect of the invention is characterized in that the raw material mixture comprising water is a particulate mixture that can be scattered. It is a benefit of such embodiment that the amount of water is limited, therefore, processability is facilitated. Use of scattering to arrange the raw material mixture into panel-shape is a very effective way for providing the panel-shape.

A preferred embodiment of the first aspect of the invention is characterized in that the raw material mixture comprises fillers, wherein the fillers comprise wood chips and/or wood fibers.

Such fillers act as reinforcement in the ceramic board, this way, achieving the required mechanical properties—e.g. bending strength—is facilitated. This facilitates milling of coupling parts at the edges of the panels obtained according to the method of the first aspect of the invention. Furthermore, the presence of wood chips and/or wood fibers allows laminating a décor layer onto the ceramic board using a melamine resin or another resin.

A preferred embodiment of the first aspect of the invention is characterized in that the raw material mixture comprises reinforcement fibers. More preferably, the reinforcement fibers provide between 0.75 and 5 percent by mass of the dry mass of the raw material mixture. Such embodiments provide ceramic board with the required mechanical properties, e.g. bending strength.

Preferably, the reinforcement fibers are textile fibers or wood fibers.

Preferably, the reinforcement fibers are selected from one or more than one of:
wood fibers;
synthetic fibers, such as e.g. polyethylene fibers, polypropylene fibers, polyester fibers, polyvinyl alcohol fibers, polyamide fibers, acrylic fibers, aramid fibers;
cellulose fibers, such as e.g. cotton, flax, hemp, bamboo, jute, sisal, miscanthus fibers, or coconut fibers;
animal fibers, such as wool or other animal hairs;
inorganic fibers, such as e.g. glass fibers, basalt fibers, metal fibers, or carbon fibers.

Such embodiments allow to optimize the mechanical properties—e.g. the bending strength—of the ceramic board.

Preferably, the average length of the reinforcement fibers is between 3 and 40 mm, more preferably between 3 and 20 mm. Such embodiments provide the optimum between the processability of the raw material mixture and the mechanical properties of the ceramic board.

A preferred embodiment of the first aspect of the invention is characterized in that the average aspect ratio of the reinforcement fibers is between 75 and 1000, more preferably between 75 and 400. The aspect ratio is determined by dividing the length of the reinforcement diameters by the apparent diameter of the reinforcement fibers. Such embodiments provide the optimum between the processability of the raw material mixture and the mechanical properties of the ceramic board.

A preferred embodiment of the first aspect of the invention is characterized in that the reinforcement fibers have been pretreated to improve the compatibility of the reinforcement fibers for adhesion in the ceramic board, more preferably wherein the pretreatment can be a treatment with a silane, a thermal treatment, or application of a sizing or coating. It is a benefit that a ceramic board is obtained with even better mechanical properties, e.g. better bending strength.

A preferred embodiment of the first aspect of the invention is characterized in that the raw material mixture comprising water is a particulate mixture; and that the raw material mixture is arranged in panel-shape by means of scattering this particulate mixture; optionally followed by an equalizing operation, e.g. by means of a roller.

It is a benefit of the invention that a very efficient method can be used for bringing the raw material mixture into panel-shape. The limited amount of water in the raw material mixture has the further benefit that less water needs to be removed.

Preferably, the scattering is performed on a continuously moving device, e.g. on a continuously moving belt. It is a benefit of this embodiments that a continuous process can be used, resulting in a very efficient process.

A preferred embodiment of the first aspect of the invention is characterized in that the raw material mixture comprising water is provided as a slurry. The slurry is arranged into panel-shape, e.g. by means of casting or by means of extrusion. Such embodiments provide an efficient way for providing the raw material mixture into panel-shape. It is e.g. possible to extrude the raw material mixture directly in panel shape. It is also possible to cast the raw material mixture into panel-shape onto a continuously moving belt.

A preferred embodiment of the first aspect of the invention is characterized in that the compacting is performed by means of a continuous press operation—whether or not at elevated temperature—; e.g. by means of a double belt press; or by means of a short cycle press or by means of a multidaylight press. Such embodiments provide a very efficient process.

In more preferred embodiments, the compacting performed by means of a continuous press operation is done in line with a continuous operation of arranging the raw material mixture into panel-shape, e.g. by means of scattering, extrusion or casting.

A preferred embodiment of the first aspect of the invention is characterized in that in the step of compacting the panel-shaped mixture by means of pressure, a surface texture is created on its surface. It is a benefit of this embodiment that a surface texture is created when the product is still soft, which means that the surface texture can be created easily. The surface texture will be maintained in the final ceramic board.

The surface texture can e.g. be a wood texture or a texture of natural stone (e.g. a marble structure). It means that an imitation can be made of a wood panel or a natural stone tile.

The surface texture can be created in register with a color pattern provided at the surface by scattering two different raw material mixtures, e.g. wherein the raw material mixtures differ in color, e.g. due to differences in the amount of or type of pigments in the two different raw material mixtures. Such embodiment provides an easy way for providing a decorative panel, e.g. a decorative floor panel.

In preferred embodiments, the surface texture is obtained by means of a textured press element or by means of a textured mold. Because the material is still soft when the pressing operation is performed, the surface texture can be made easily and requiring only limited amount of pressure.

A preferred embodiment of the first aspect of the invention is characterized in that in the step of compacting the panel-shaped mixture by means of pressure a texture is created on the surface that will form the bottom of the ceramic board. Such embodiments have the benefit that a texture at the bottom of the ceramic board while the material is still soft. A texture at the bottom of the ceramic board is of interest when the ceramic board forms the bottom of the panel when the panel is installed by means of an adhesive.

A preferred embodiment of the first aspect of the invention is characterized in that during or after arranging the raw material mixture into panel-shape water is added. This embodiment allows to ensure that the amount of water is optimized for the process of making the ceramic board.

When water is added during or after arranging the raw material mixture into panel-shape, preferably the water that is added comprises additives such as one or more than one of a release agent, an inhibitor or a hydrophobic agent. This embodiment provides optimum processability.

Preferably, the water is added by means of spraying. This is a very effective way of adding water.

A preferred embodiment of the first aspect of the invention is characterized in that the raw material mixture comprises additives, wherein the additives comprise a superplasticizer, e.g. polycarboxylate ether. Such embodiments have the benefit that the steps of arranging the raw material mixture into panel-shape; and of compacting the panel-shaped mixture by means of pressure are facilitated. Therefore, the panel-shape is better compacted. A better compacted panel-shaped means that the resulting ceramic board will be less porous, and therefore have better properties, e.g. better mechanical properties (e.g. bending strength) and better resistance to moisture.

A preferred embodiment of the first aspect of the invention is characterized in that the raw material mixture comprises additives, wherein the additives comprise a superabsorbent, optionally selected from sodium polyacrylate, polyacrylamide copolymer, ethylene maleic anhydride copolymer, cross-linked carboxymethylcellulose, polyvinyl alcohol copolymer, cross-linked polyethylene oxide, starch grafted on polyacrylonitrile.

A raw material mixture comprising a superabsorbent has the benefit that it more easy to have a raw material mixture that is a particulate mixture that can be scattered. A superabsorbent can absorb a lot of moisture, while still feeling dry. In the method step of compacting the raw material mixture, water is released from the superabsorbent such that this water can ply its role in the process of formation of the geopolymer bonds.

A preferred embodiment of the first aspect of the invention is characterized in that the raw material mixture comprises additives, wherein the additives comprise a chelating agent, e.g. EDTA or phosphonic acid. Such embodiments improve the formation of the geopolymer.

A preferred embodiment of the first aspect of the invention is characterized in that the raw material mixture comprises additives, wherein the additives comprise a hydrophobic agent, e.g. metal soap, silanes, siloxanes, acrylates or latex. Such embodiments have the benefit that a ceramic board is obtained which has better moisture resistance.

A preferred embodiment of the first aspect of the invention is characterized in that the raw material mixture comprises additives, wherein the additives comprise pigments (preferably inorganic pigments) or decorative particles (e.g. shells, marble powder or granite powder) for decorating the surface of the ceramic board. Such embodiments have the benefit that a panel with a decorative surface can be obtained in a simple way.

A preferred embodiment of the first aspect of the invention is characterized in that in the method two raw material mixtures are used. The raw material mixtures differ in color, e.g. by comprising different amounts of pigments or decorative particles and/or by comprising different kinds or colors of pigments and/or decorative particles. The two raw material mixture are arranged into panel-shape—e.g. by means of a computer controlled scattering operation—such that each of the two raw material mixtures provide part of the surface of the panel-shape. This way a decorative color pattern can be obtained in a simple way at the surface of the panel.

A preferred embodiment of the first aspect of the invention is characterized in that in the step of arranging the raw material mixture into panel-shape at least two layers are formed, wherein at least two of the at least two layers differ in composition of the raw material mixture. More preferably two layers are formed; or more preferably three or at least three layers are formed.

Such embodiments allow to create layers with different properties. This way, the panel as a whole can be provided with better properties. It is e.g. possible to color the uppermost layer, while the other layers are not provided with coloration. It is also possible to provide a kind of sandwich structure in the ceramic board, with different properties in the middle or core layer than in the two outer layers.

In a preferred embodiment wherein the raw material mixture is arranged into panel-shape wherein at least two layers are formed in the panel-shape, the at least two layers comprise an uppermost layer and a second layer contacting the uppermost layer. In the ceramic board the uppermost layer is harder and/or more brittle than the second layer. Such embodiments allow to optimize the mechanical properties of the ceramic board.

Optionally, the at least two layers comprise a third layer at the opposite side of the second layer from the uppermost layer, wherein in the ceramic board the third layer is harder and/or more brittle than the second layer. Such embodiments allow to optimize the mechanical properties of the ceramic board.

A preferred embodiment is characterized in that the at least two layers comprise an uppermost layer and a second layer contacting the uppermost layer, wherein the raw material mixture for the uppermost layer comprises pigments (preferably inorganic pigments) or decorative particles (e.g. shells, marble powder or granite powder) for decorating the surface of the ceramic board; whereas the raw material mixture for the second layer comprises no or less pigments and/or decorative particles. It is a benefit of such embodiments that a panel with decorative surface can be made in a very efficient way.

A preferred embodiment is characterized in that the at least two layers comprise an uppermost layer and a second layer contacting the uppermost layer, wherein the raw material mixture for the uppermost layer comprises per unit of its dry mass a larger amount of reinforcement fibers and/or wood fillers (e.g. wood chips and/or wood fibers) than the raw material mixture for the second layer. Such embodiments allow to optimize the mechanical properties of the panel, e.g. its mechanical properties.

A preferred embodiment of the first aspect of the invention is characterized in that the method comprises the step wherein the surface of the ceramic board is mechanically treated, e.g. by means of polishing or by means of sand blasting, in order to obtain a visual surface effect (e.g. to obtain a shiny surface or an artificial aging). More preferably the ceramic board comprises pigments (preferably inorganic pigments) or decorative particles (e.g. shells, marble powder or granite powder).

A preferred embodiment of the first aspect of the invention is characterized in that the panel comprises a decor layer; wherein the method comprises the step of applying the decor layer onto the ceramic board. It is a benefit of such embodiments that a decorative panel is obtained that is ceramic in nature and that can be made in an environmentally friendly way.

A preferred embodiment of the first aspect of the invention is characterized in that a decor layer is at least obtained by printing—preferably by means of digital printing (e.g. with UV curing ink, with water based ink or with solvent based ink) onto the ceramic board. Such embodiments provide a very effective way of providing a décor layer onto the ceramic board.

More preferably after the printing, a coating is applied, more preferably a UV-curing or thermally curing acrylate coating or epoxy coating. The application of the coating allows to provide the panel surface with optimized properties.

Preferably, the printing is provided in register with a texture at the surface of the panel, preferably in register with a texture at the surface of the ceramic board. This way, a decorative panel can be obtained showing a realistic imitation of a panel out of a natural material, e.g. a wood panel or a panel out of a natural stone material (e.g. marble).

A preferred embodiment of the first aspect of the invention is characterized in that the decor layer is at least obtained by introduction in the raw material mixture—or at least by introduction in the raw material mixture providing the top section of the ceramic board—of pigments (preferably inorganic pigments) or decorative particles (e.g. shells, marble powder or granite powder) for decorating the surface of the ceramic board. This is a very efficient method for providing a décor, limiting the steps required for creating the décor layer.

A preferred embodiment of the first aspect of the invention is characterized in that the decor layer is at least obtained by coloring or staining the surface of the ceramic board, more preferably wherein the ceramic board is provided with a texture.

More preferably, the coloring or staining is followed by the application of a coating, preferably a UV-curing or thermally curing acrylate coating or epoxy coating. The application of the coating allows to provide the panel surface with optimized properties.

A preferred embodiment of the first aspect of the invention is characterized in that the decor layer is at least obtained by adhering by means of an adhesive a layer of stone—e.g. a layer of stone veneer—onto the ceramic board. This way, in a cost effective and environmentally friendly way, a decorative panel can be obtained having a natural stone material (e.g. marble) as surface.

A preferred embodiment of the first aspect of the invention is characterized in that the decor layer is at least obtained by laminating a décor layer onto the ceramic board, wherein the décor layer comprises a decorative print, preferably a printed paper sheet. Such embodiments allow to provide the panel with a décor layer in a very effective way.

In preferred embodiments, the décor layer is or comprises a High Pressure Laminate (HPL), wherein the High Pressure Laminate is bonded into the panel by means of an adhesive; more preferably wherein the High Pressure Laminate is bonded onto the ceramic board by means of the adhesive.

A preferred embodiment of the first aspect of the invention is characterized in that the décor layer is or comprises a sheet of printed paper impregnated with a resin (e.g. a melamine formaldehyde resin, an acrylate resin or a polyester resin), wherein the décor layer is laminated into the panel—and preferably bonded onto the ceramic board—by means of an adhesive (e.g. vinyl acetate, acrylate, vinyl-acrylate copolymer, polyurethane, whether or not comprising a crosslinker, e.g. carbodiimide) or by means of the resin of the sheet of printed paper. Such embodiments allow to provide the panel with a décor layer in a very effective way.

A preferred embodiment of the first aspect of the invention is characterized in that at the same time of applying the décor layer, or after application of the décor layer, a wear layer is laminated into the panel.

The wear layer is laminated into the panel by means of an adhesive (e.g. vinyl acetate, acrylate, vinyl-acrylate copolymer, polyurethane, whether or not comprising a crosslinker, e.g. carbodiimide) or preferably if the wear layer is or comprises a sheet of paper impregnated with a resin, by means of the resin of the sheet of paper impregnated with a resin. Such embodiments provide a panel with high wear resistance, e.g. for use as floor panel.

Optionally, the wear layer is or comprises a sheet of paper impregnated with a resin. Such embodiments facilitate the way of applying the wear layer in the panel.

Preferably the wear layer comprises wear resistant particles, e.g. corundum. Such embodiments provide panels with even better wear resistance.

A preferred embodiment of the first aspect of the invention is characterized in that the step of compacting the panel-shaped mixture by means of pressure is performed at a pressure of at least 500 N/cm², more preferably of at least 1000 N/cm², even more preferably of at least 1500 N/cm². Such embodiments ensure that ceramic boards are obtained with low porosity and with appropriate properties, e.g. appropriate mechanical properties and good moisture resistance. Especially a high bending strength is important for panels according to the invention. Especially when the panels are thin.

A preferred embodiment of the first aspect of the invention is characterized in that in the step of applying a temperature between 50 °C and 200 °C (and preferably below 150 °C, more preferably below 120 °C) to the compacted panel-shaped mixture during a time period, a compacting pressure is maintained onto the panel-shaped mixture; wherein the compacting pressure is at least 500 N/cm², preferably at least 1000 N/cm², more preferably at least 1500 N/cm².

Such embodiments provides ceramic boards with low porosity after curing. This way, better mechanical properties are obtained, among which a higher bending strength. A high bending strength is especially of relevance for thin panels. The low porosity of the ceramic board provides better moisture resistance.

The second aspect of the invention relates to a panel, preferably a decorative panel, characterized in that the panel comprises at least a ceramic board bonded by a geopolymer selected from an amorphous or a semi-crystalline polysialate geopolymer, an amorphous or a semi-crystalline poly(sialate-siloxo) geopolymer; or an amorphous or a semi-crystalline poly(sialate-disiloxo) geopolymer. Optionally, the panel is produced according to a method as in any embodiment of the first aspect of the invention.

It is a benefit that a panel is obtained that can be made with low energy consumption, using materials and processes that are environmentally friendly.

A preferred embodiment of the second aspect of the invention is characterized in that the ceramic board is less than 60 mm thick, more preferably less than 30 mm thick, more preferably less than 20 mm thick, more preferably less than 14 mm thick, more preferably less than 10 mm thick, even more preferably less than 8 mm thick.

Such embodiments provide panels that have excellent mechanical properties, e.g. bending strength. The panels are e.g. suited for use as floor panels.

A preferred embodiment of the second aspect of the invention is characterized in that the bonded ceramic board comprises wood chips and/or wood fibers. It is a benefit of such embodiments that the wood chips and/or wood fibers provide improved properties of the bonded ceramic board. It is a further benefit of wood chips and/or wood fibers in the ceramic board that they can provide adhesion to a decorative layer applied onto the ceramic board.

A preferred embodiment of the second aspect of the invention is characterized in that the bonded ceramic board comprises reinforcement fibers. Such embodiments provide ceramic board with the required mechanical properties, e.g. bending strength.

Preferably, the reinforcement fibers are textile fibers or wood fibers.

Preferably wherein preferably wherein the reinforcement fibers provide between 0.75 and 5 percent by mass of ceramic board. Such embodiments provide ceramic board with the required mechanical properties, e.g. bending strength.

Preferably, the reinforcement fibers are selected from one or more than one of
wood fibers:
synthetic fibers, such as e.g. polyethylene fibers, polypropylene fibers, polyester fibers, polyvinyl alcohol fibers, polyamide fibers, acrylic fibers, aramid fibers;
cellulose fibers, such as e.g. cotton, flax, hemp, bamboo, jute, sisal, miscanthus fibers, or coconut fibers;
animal fibers, such as wool or other animal hairs;
inorganic fibers, such as e.g. glass fibers, basalt fibers, metal fibers, or carbon fibers.

Such embodiments allow to optimize the mechanical properties—e.g. the bending strength—of the ceramic board.

In a preferred embodiment, the average length of the reinforcement fibers is between 3 and 40 mm, more preferably between 3 and 20 mm.

As such embodiments provide the optimum between the processability of the raw material mixture and the mechanical properties of the ceramic board, such embodiments provide a panel with optimum quality.

A preferred embodiment of the second aspect of the invention is characterized in that the average aspect ratio of the reinforcement fibers is between 75 and 1000, more preferably between 75 and 400. The aspect ratio is determined by dividing the length of the reinforcement diameters by the apparent diameter of the reinforcement fibers. Such embodiments provide the optimum between the processability of the raw material mixture and the mechanical properties of the ceramic board.

A preferred embodiment of the second aspect of the invention is characterized in that the surface of the panel comprises a decorative texture; preferably a wood texture or a natural stone texture, e.g. a marble texture. Such embodiments provide panels that show a realistic imitation of a panel of natural material, e.g. of a wood panel or of a natural stone tile (e.g. of a marble tile).

A preferred embodiment of the second aspect of the invention is characterized in that the bottom of the panel—which is preferably the bottom of the ceramic board—comprises a texture. Such embodiments are beneficial as installation using an adhesive or a mortar is facilitated.

A preferred embodiment of the second aspect of the invention is characterized in that the ceramic board comprises fillers, wherein the fillers comprise powders or granulates, e.g. CaCO₃ or sand. The fillers allow optimization of the properties and cost of the ceramic board.

A preferred embodiment of the second aspect of the invention is characterized in that the ceramic board comprises pigments (preferably inorganic pigments) or decorative particles (e.g. shells, marble powder or granite powder) for decorating at least the surface of the ceramic board. Such embodiments have the benefit that a panel with a decorative surface can be obtained in a simple way.

A preferred embodiment of the second aspect of the invention is characterized in that the ceramic board comprises a decorative surface at least provided by at least two regions that differ in their relative amount and/or kind and/or color of colored or decorative particles. It is a benefit of such embodiments that a decorative surface can be obtained in an easy way, with little extra effort in the production of the panel.

A preferred embodiment of the second aspect of the invention is characterized in that the ceramic board comprises at least two layers; wherein the at least two layers differ in composition; e.g. in the relative amount of fillers.

This way, the panel as a whole can be provided with better properties. It is e.g. possible to color the uppermost layer, while the other layers are not provided with coloration. It is also possible to provide a kind of sandwich structure in the ceramic board, with different properties in the middle or core layer than in the two outer layers.

More preferably, the ceramic layer comprises at least three layers.

A preferred embodiment of the second aspect of the invention is characterized in that the ceramic board comprises at least two layers; wherein the at least two layers differ in composition; e.g. in the relative amount of fillers. The at least two layers comprise an uppermost layer and a second layer contacting the uppermost layer, wherein in the ceramic board the uppermost layer is harder and/or more brittle than the second layer. Such embodiments allow to optimize the mechanical properties of the ceramic board.

Optionally, the at least two layers comprise a third layer at the opposite side of the second layer from the uppermost layer, wherein in the ceramic board the third layer is harder and/or more brittle than the second layer. Such embodiments allow to optimize the mechanical properties of the ceramic board.

A preferred embodiment of the second aspect of the invention is characterized in that the at least two layers comprise an uppermost layer and a second layer contacting the uppermost layer, wherein the uppermost layer comprises pigments (preferably inorganic pigments) or decorative particles (e.g. shells, marble powder or granite powder) for decorating at least the surface of the ceramic board; whereas the second layer comprises no or less pigments and/or decorative particles. It is a benefit of such embodiments that a panel with decorative surface can be made in a very efficient way.

A preferred embodiment of the second aspect of the invention is characterized in that the at least two layers comprise an uppermost layer and a second layer contacting the uppermost layer, wherein the mass percentage of reinforcement fibers and/or wood fillers (preferably wood chips and/or wood fibers) is higher in the uppermost layer than in the second layer.

Such embodiment facilitate the adhesion of a décor layer onto the uppermost layer when using an adhesive such as a melamine resin or another resin.

A preferred embodiment of the second aspect of the invention is characterized in that the ceramic layer comprises at least three layers or consists of three layers, wherein the layers comprise an uppermost layer, a second layer and a third layer; wherein the second layer is provided between the uppermost layer and the third layer; wherein the mass percentage of reinforcement fibers and/or wood fillers (e.g. wood chips and/or wood fibers) is higher in the uppermost layer and/or in the third layer than in the second layer.

Such embodiments provide panels in which coupling parts can be provided in a more reliable way. The coupling parts can be used for coupling then panels during their installation into a floor covering or wall covering. With panels according to such embodiments, the coupling can be provided in a more reliable and more durable way.

A preferred embodiment of the second aspect of the invention is characterized in that the ceramic board—or at least the upper layer of the ceramic board—comprises pigments (preferably inorganic pigments) or decorative particles (e.g. shells, marble powder or granite powder) for decorating the surface of the ceramic board. Such embodiments provide panels having a decorative surface in a very efficient way, with little extra effort during the production process of the panels.

A preferred embodiment of the second aspect of the invention is characterized in that the panel comprises a decor layer.

A preferred embodiment of the second aspect of the invention is characterized in that a decor layer is at least provided by a decorative print. More preferably, the decorative print is provided by means of digital printing; e.g. with UV curing ink, with water based ink or with solvent based ink on the ceramic board.

Digital printing is a very flexible way for creating a printed décor on panels according to the invention.

More preferably, the decor layer comprises a coating, preferably a UV-curing or thermally curing acrylate coating or epoxy coating.

A preferred embodiment of the second aspect of the invention is characterized in that a decorative print is provided in register with a texture at the surface of the panel, more preferably in register with a texture at the surface of the ceramic board. This way, a decorative panel can be provided showing a realistic imitation of a panel out of a natural material, e.g. a wood panel or a panel out of a natural stone material (e.g. marble).

A preferred embodiment of the second aspect of the invention is characterized in that the decor layer is at least obtained by coloring or staining of the surface of the panel. More preferably by coloring or staining of the surface of the ceramic board of the ceramic board.

A preferred embodiment of the second aspect of the invention wherein the decor layer is at least obtained by coloring or staining of the surface of the panel is characterized in that the surface of the panel—and more preferably the surface of the ceramic board—comprises a texture; preferably wherein the coloring or staining shows a gradation according to the texture.

A preferred embodiment of the second aspect of the invention is characterized in that the decor layer comprises a top coating, more preferably a UV-curing or thermally curing acrylate coating or epoxy coating. Such embodiments provide panels with excellent properties of the surface of the panel.

A preferred embodiment of the second aspect of the invention is characterized in that the decor layer comprises or consists of a layer of stone—e.g. a layer of stone veneer—glued onto the ceramic board. It is a benefit that a nice decorative surface can be obtained while use of the expensive product—the layer of stone—is limited.

A preferred embodiment of the second aspect of the invention is characterized in that the decor layer is at least obtained by laminating a décor layer onto the ceramic board, wherein the décor layer comprise a decorative print, preferably a printed paper sheet. It is a benefit of such embodiments that a flexible way is provided for providing a ceramic panel with a décor layer.

A preferred embodiment of the second aspect of the invention is characterized in that the décor layer is or comprises a High Pressure Laminate (HPL), wherein the High Pressure Laminate is bonded into the panel by means of an adhesive. More preferably, the High Pressure Laminate is bonded onto the ceramic board by means of the adhesive.

A preferred embodiment of the second aspect of the invention is characterized in that the décor layer is or comprises a sheet of printed paper impregnated with a resin (e.g. a melamine formaldehyde resin, an acrylate resin or a polyester resin), wherein the décor layer is laminated into the panel—and preferably bonded onto the ceramic board—by means of an adhesive (e.g. vinyl acetate, acrylate, vinyl-acrylate copolymer, polyurethane, whether or not comprising a crosslinker, e.g. carbodiimide) or by means of the resin of the sheet of printed paper.

Especially when the ceramic board—or its uppermost layer—comprise wood particles, e.g. wood chips and/or wood fibers, such embodiments provide an efficient way of the providing a décor to the panel surface. The presence of the wood particles improves the adhesion between the ceramic board and the resin of the sheet of printed paper impregnated with resin.

A preferred embodiment of the second aspect of the invention is characterized in that the panel comprises a wear layer. wherein the wear layer is laminated into the panel by means of an adhesive (e.g. vinyl acetate, acrylate, vinyl-acrylate copolymer, polyurethane, whether or not comprising a crosslinker, e.g. carbodiimide) or preferably if the wear layer is or comprises a sheet of paper impregnated with a resin, by means of the resin of the sheet of paper impregnated with a resin. Such embodiments provide a panel with high wear resistance, e.g. for use as floor panel.

Optionally, the wear layer is or comprises a sheet of paper impregnated with a resin.

Preferably, the wear layer comprises wear resistant particles, e.g. corundum.

A preferred embodiment of the second aspect of the invention is characterized in that the panel is rectangular, wherein the panel is square or oblong, wherein the panel comprises at at least two opposite edges coupling parts for coupling the panel with another such panel at their respective edges such that in coupled condition a locking is obtained in the direction perpendicular to the surface of the coupled panels as well as in the direction perpendicular to the coupled edges and parallel with the surface of the coupled panels; wherein the coupling parts comprise a male part provided by a tongue; wherein the coupling parts comprise a female part comprising a groove bordered by a lower lip and by an upper lip. Such embodiments provide ease of installation of the panels, e.g. in a floor covering or in a wall covering. Floating installation of the panels in a floor covering is possible.

A preferred embodiment of the second aspect of the invention is characterized in that the coupling parts are substantially provided by on the one hand a tongue and on the other hand a groove bordered by a lower lip and by an upper lip; wherein the tongue and the groove substantially provide in coupled condition the locking in the direction perpendicular to the surface of the coupled panels; wherein the tongue and groove comprise locking parts, wherein the locking parts substantially provide in coupled condition the locking in the direction perpendicular to the coupled edges and parallel with the surface of the coupled panels; preferably the locking parts comprise a protrusion at the lower lip and a corresponding recess at the bottom of the tongue. Such embodiments provide ease of installation of the panels, e.g. in a floor covering or in a wall covering. Floating installation of the panels in a floor covering is possible.

A preferred embodiment of the second aspect of the invention is characterized in that the coupling can be performed by means of an angling movement of the respective edges of the panels to be coupled. Panels according to such embodiments can be installed into a floor covering in a very efficient way.

A preferred embodiment of the second aspect of the invention is characterized in that the coupling parts are configured such that at the coupled edges of the panel coupled with the another such panel the imitation of a joint of a certain width is provided, optionally wherein at the joint a grout can be obtained and/or a coating is provided onto at least part of the coupling parts.

Such embodiments allow to provide the appearance of grouted tiles after installation of the panels.

A preferred embodiment of the second aspect of the invention is characterized in that one or both of the at least two opposite edges are at least partly provided with a hydrophobic coating. Such embodiments result after installation of the panels in coverings which are better resistant to water and moisture.

A preferred embodiment of the second aspect of the invention is characterized in that the ceramic layer comprises an uppermost layer and a second layer contacting the uppermost layer, wherein in the ceramic board the uppermost layer is harder and/or more brittle than the second layer; wherein the tongue is substantially or completely provided in the second layer. This way, a more sturdy and a more reliable coupling can be achieved between the panels.

Optionally, the at least two layers comprise a third layer at the opposite side of the second layer from the uppermost layer. The third layer is harder and/or more brittle than the second layer. This way, a more sturdy and a more reliable coupling can be achieved between the panels.

The third aspect of the invention is a panel as in any embodiment of the second aspect of the invention, characterized in that the panel is a floor panel.

Preferably, the floor panel is thinner than 20 mm. More preferably the thickness of the floor panel is between 8 and 14 mm thick.

The fourth aspect of the invention is a floor covering, characterized in that the floor covering comprises a number of panels as in any embodiment of the third aspect of the invention.

The fifth aspect of the invention is a panel as in any embodiment of the second aspect of the invention, characterized in that the panel is a wall panel.

Preferred wall panels are less than 5 mm thick.

The fifth aspect of the invention is a wall covering, characterized in that the wall covering comprises a number of wall panels as in any embodiment of the fifth aspect of the invention.

Embodiments of the different aspects of the invention wherein the décor layer is at least obtained by digital printing on the ceramic board can comprise one or a combination of more than one of the following features:
the surface of the ceramic board which will be digitally printed is sanded;
a water-based silane is applied onto the surface of the ceramic board which will be digitally printed. Preferably, the water-based silane acts as primer and/or as coupling agent;
application of an acrylate primer, more preferably a UV-curing acrylate primer. Preferably, between 5 and 20 gram solids per square meter of acrylate primer is applied. Preferably, the UV-curing acrylate primer is gelled, preferably using a Hg-bulb, a Ga-bulb of a LED.
application before the digital printing operation of one or more than one white base layers, more preferably white UV-curing acrylate base layers;
application after digital printing of a wear layer—e.g. via a UV-curing acrylate. More preferably, the wear layer comprises UV-absorbers, preferably UV-A absorbers and/or Hindered-Amine Light Stabilisers;
application of a texture on the digitally printed surface by means of digital texturing.

With the intention of better showing the characteristics of the invention, hereafter, as an example without any limitative character, several preferred embodiments are described, with reference to the accompanying drawings, wherein:

figure represents 1 a floor covering comprising decorative panels according to the invention;

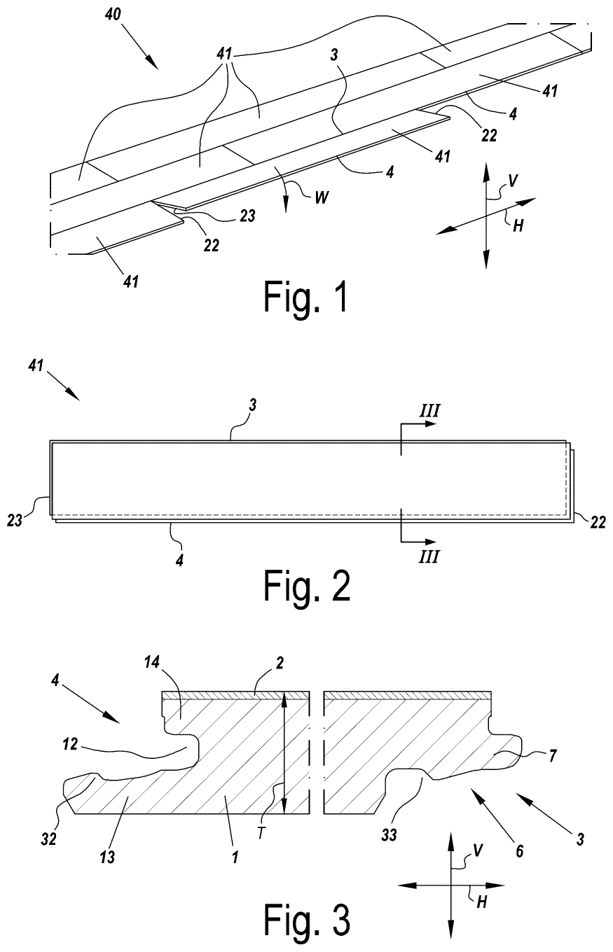

FIG. 2 show a decorative panel—according to the invention—as used in the floor covering of FIG. 1;

FIG. 3 represents cross section according to III-III of the panel of FIG. 2.

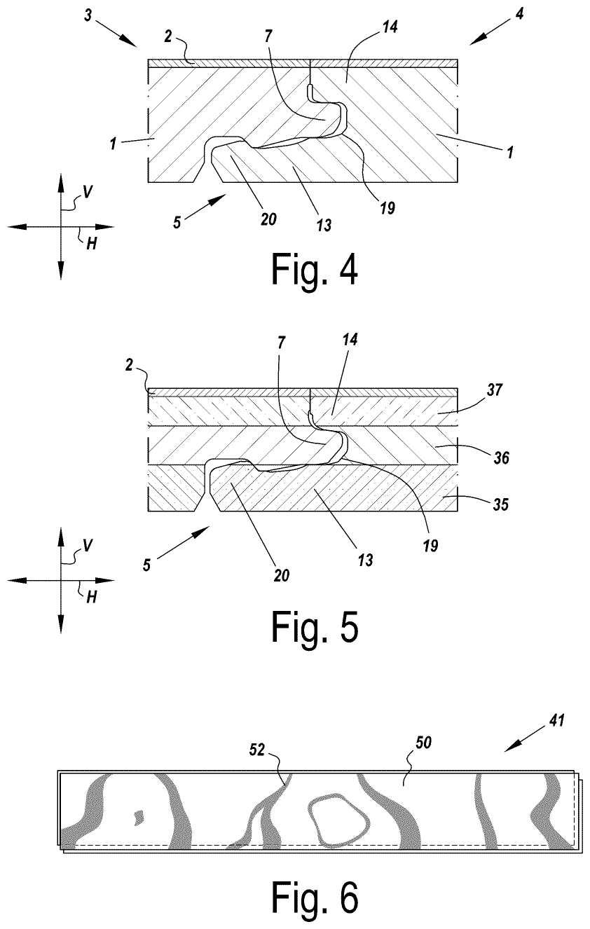

FIG. 4 shows two panels as in FIGS. 2 and 3 coupled at their long edges;

FIG. 5 shows an example of a panel according to the invention, in coupled condition, wherein the ceramic geopolymer board of the panels comprise three different layers consisting out of geopolymer.

FIG. 6 shows the surface of an embodiment of a decorative panel according to the invention.

FIG. 1 shows a floor covering 40 comprising decorative panels 41 according to the invention. The decorative panels 41 are coupled at their first pair of opposite edges 3, 4 by means of their respective coupling parts; and are also coupled at their first pair of opposite edges 22, 23. Wall coverings according to the invention can be arranged in the same way.

FIG. 2 shows a panel 41 as used in the floor covering of FIG. 1. The panel is rectangular and oblong; and comprises at its long edges a first pair of opposite edges 3, 4 comprising coupling parts. The short pair of opposite edges 22, 23 also comprises coupling parts. The coupling parts 22, 23 of the short pair of opposite edges can be configured in a similar way as the coupling parts at the long edges. However, this is not essential for the invention.

FIGS. 3 and 4 represent an example of a panel shown in FIG. 2. FIG. 3 represents a cross section according to III-III of the panel of FIG. 2. FIG. 4 shows two panels as in FIG. 2 coupled at their long edges 3, 4, which means coupled at the edges shown in FIG. 3.

The panel of FIG. 2-4 comprises a ceramic board 1 bonded by a geopolymer selected from an amorphous or a semi-crystalline polysialate geopolymer, an amorphous or a semi-crystalline poly(sialate-siloxo) geopolymer; or an amorphous or a semi-crystalline poly(sialate-disiloxo) geopolymer. The panel comprises a decor layer 2 applied onto the ceramic board 1. The panel has thickness T. The ceramic board 1 can comprise reinforcement fibers.

The panel is provided at its long opposite edges 3, 4 with coupling parts 5 allowing that two such panels can be coupled at their respective edges in coupled condition such that a locking is obtained in the direction V perpendicular to the surface of the coupled panels as well as in the direction H perpendicular to the coupled edges and parallel with the surface of the coupled panels. Coupling the panels can be performed by an angling movement W, as indicated in FIG. 1.

The coupling parts 5 of the first edge 3 of the two long opposite edges 3, 4 comprise a male part 6 provided by a tongue 7. The other edge 4 comprise a female part comprising a groove 12 bordered by a lower lip 13 and by an upper lip 14.

The lower lip 13 comprises a protrusion 32 providing a locking part; and the bottom of the tongue 7 comprises a recess 33 providing a locking part. The locking parts 32, 33 substantially provide in coupled condition the locking in the direction perpendicular to the coupled edges and parallel with the surface of the coupled panels; preferably FIG. 5 shows an example of panels according to the invention, in coupled condition. The ceramic board comprises three layers, an uppermost layer 37, a second layer 36 and a third layer 35. Each of the layers 35, 36, 37 is bonded by a geopolymer selected from from an amorphous or a semi-crystalline polysialate geopolymer, an amorphous or a semi-crystalline poly(sialate-siloxo) geopolymer; or an amorphous or a semi-crystalline poly(sialate-disiloxo) geopolymer. The polycondensation reactions forming the geopolymer bonds in the layers are carried out after building the layer structure, as a consequence, during the polycondensation reaction, geopolymer bonds are also formed between the layers. The coupling parts of the panels of FIG. 5 are configured in the same way as in FIGS. 3 and 4. The reference numerals of FIG. 5 have the same meaning as the reference numerals in FIGS. 3 and 4.

At least two of these three layers 35, 36, 37 differ in composition. Preferably, the second layer 36 has another composition than the uppermost layer 37; and preferably also than the third layer 35. The tongue 7 is substantially provided in the second layer 36. The lower lip 13 is substantially provide in the third layer 35. The upper lip 14 is substantially provided in the uppermost layer 37.

It is preferred that the mass percentage of reinforcement fibers and/or wood fillers (e.g. wood chips and/or wood fibers) is higher in the uppermost layer 37 and in the third layer 35 than in the second layer 36.

FIG. 6 shows the surface of an embodiment of a decorative panel 41 according to the invention. The surface of the ceramic board comprises two different regions 50, 52 which differ in color, this way a decorative color pattern is obtained at the surface of the ceramic board, which provides the surface of the ceramic board. In the example shown, a black vein 52 (black because this portion of the surface is derived from a raw material mixture comprising black pigments) contrasts with a background 50 of lighter color (as this part of the surface of the ceramic board is derived from a raw material mixture of while or light color). The surface imitates marble. Both raw material mixtures have been brought appropriately arranged in panel-shape by scattering operations, locating the two raw material mixture in the correct position in the panel-shape. This is followed by the compacting step and the step in which the polycondensation reactions occur.

An example of a raw material mixture for use in the invention has been composed as follows:
100 parts by weight of fly ash, fly ash which is composed substantially of aluminosilicate particles;
5 parts by weight of polyvinyl alcohol fibers of 6 mm length and 6 micrometer diameter; and
150 parts by weight of CaCO₃.

These ingredients are mixed. Added are
40 parts by weight of a 14 molar NaOH solution;
40 parts by weight of Na-waterglass. The waterglass used comprises 30 percent by weight of SiO₂ solids and 15 percent by weight of Na₂O solids.

Mixing is performed, thereby obtaining a raw material mixture. This raw material mixture is a particulate mixture. This particulate mixture is arranged in panel-shape by scattering the particulate mixture into a mold, and prepressed, after which the mold is removed. This panel-shape is then compacted in a press during 20 minutes at 1000 N/cm² pressure and at 90 °C temperature using a structured press plate. The structured press plate impresses a texture into the panel; this texture is present in the final panel. The panel is removed from the press and post-curing is performed during 5 days at room temperature in atmospheric condition, followed by 48 hours at 90 °C in dry air, again followed by 7 days at room temperature in atmospheric condition.

This way, a 9.5 mm thick geopolymer ceramic board was obtained comprising the texture at its surface. The geopolymer ceramic board has good mechanical properties.

After the post-curing steps a primer coating layer has been applied on the geopolymer ceramic board: 5-20 gram per square meter of a UV-curing acrylate has been applied. The primer coating layer is gelled by means of UV-radiation.

A transparent coating layer is applied which will act as wear layer. To this end 50-200 gram per square meter of a UV-curing acrylate can be applied. Optionally, this UV-curing acrylate can comprise wear resistant particles, e.g. aluminiumoxide (e.g. 5-20 percent by weight of aluminiumoxide particles with particle size between 50 and 90 micrometer). This layer is gelled by means of UV-radiation.

Finally, a topcoat is applied using 5 to 20 gram per square meter of a UV-curing acrylate, optionally comprising scratch resistant particles such as aluminiumoxide (e.g. 2 to 10 percent by weight of aluminiumoxide particles having particle size between 3 and 15 micrometer).

The combined coating layers are cured together by means of UV-radiation or by means of an electron beam. This way, a decorative wear resistant geopolymer ceramic panel is obtained that can be used as floor panel.

The present invention is in no way limited to the embodiments described as an example and/or represented in the figures, on the contrary the invention may be realized in various forms and dimensions, without leaving the scope of the invention.

1.-90. (canceled)

91. A panel, wherein the panel comprises at least a board bonded by a geopolymer selected from an amorphous or a semi-crystalline polysialate geopolymer, an amorphous or a semi-crystalline poly(sialate-siloxo) geopolymer; or an amorphous or a semi-crystalline poly(sialate-disiloxo) geopolymer.

92. The panel as in claim 91, wherein the board comprises reinforcement fibers, wherein the reinforcement fibers are selected from one or more than one of
wood fibers:
synthetic fibers;
cellulose fibers;
animal fibers;
inorganic fibers.

93. The panel as in claim 91, wherein the bottom of the panel, which provides the bottom of the board, comprises a texture.

94. The panel as in claim 91, wherein the board comprises pigments or decorative particles for decorating at least the surface of the board;
wherein the board comprises a decorative surface at least provided by at least two regions that differ in their relative amount or kind or color of pigments or decorative particles.

95. The panel as in claim 91, wherein the panel comprises a decor layer, wherein the decor layer is at least provided by a decorative print on the board.

96. The panel as in claim 91, wherein the panel comprises a décor layer;
wherein the decor layer is at least obtained by coloring or staining of the surface of the board.

97. The panel as in claim 96, wherein the surface of the board-comprises a texture;
wherein the coloring or the staining shows a gradation according to the texture.

98. The panel as in claim 91, wherein the panel comprises a décor layer, wherein the decor layer comprises or consists of a layer of stone veneer glued onto the board.

99. The panel as in claim 91, wherein the panel comprises a décor layer;
wherein the decor layer is at least obtained by laminating a décor layer onto the board, wherein the décor layer comprises a decorative print.

100. The panel as in claim 99, wherein the décor layer comprises a sheet of printed paper impregnated with a resin,
wherein the décor layer is laminated into the panel by an adhesive or by the resin of said sheet of printed paper.

101. The panel as in claim 100, wherein the panel comprises a wear layer.

102. The panel as in claim 91, wherein the panel is rectangular,
wherein the panel is square or oblong,
wherein the panel comprises at at least two opposite edges coupling parts for coupling the panel with another such panel at their respective edges such that in coupled condition a locking is obtained in the direction perpendicular to the surface of the coupled panels as well as in the direction perpendicular to the coupled edges and parallel with the surface of the coupled panels;
wherein the coupling parts comprise a male part provided by a tongue;
wherein the coupling parts comprise a female part comprising a groove bordered by a lower lip and by an upper lip.

103. The panel as in claim 102, wherein the coupling parts are substantially provided by on the one hand a tongue and on the other hand a groove bordered by a lower lip and by an upper lip;
wherein the tongue and the groove substantially provide in coupled condition the locking in the direction perpendicular to the surface of the coupled panels;
wherein the tongue and groove comprise locking parts,
wherein the locking parts substantially provide in coupled condition the locking in the direction perpendicular to the coupled edges and parallel with the surface of the coupled panels.

104. The panel as in claim 102, wherein the coupling parts are configured such that at the coupled edges of the panel coupled with the another such panel the imitation of a joint of a certain width is provided.
